(19) United States
(12) Patent Application Publication
(10) Pub. No.: US 2024/0028580 A1
(43) Pub. Date: Jan. 25, 2024

(54) METHODS AND SYSTEMS RELATED TO A UNIFIED FRAMEWORK FOR GLOBAL TABLE WITH GUARANTEE ON REPLICA DATA FRESHNESS

(71) Applicant: HUAWEI TECHNOLOGIES CO., LTD., Shenzhen (CN)

(72) Inventors: Huaxin ZHANG, Markham (CA); Ronen GROSMAN, Markham (CA); MohammadAli NIKNAMIAN, Kanata (CA)

(73) Assignee: HUAWEI TECHNOLOGIES CO., LTD., Shenzhen (CN)

(21) Appl. No.: 17/870,887

(22) Filed: Jul. 22, 2022

(51) Int. Cl. G06F 16/23; G06F 16/22; G06F 16/27

(52) U.S. Cl. CPC G06F 16/235; G06F 16/2282; G06F 16/27

(57) ABSTRACT

The present disclosure provides for methods and systems related to a unified framework for global table with guarantee on replica data freshness. According to a first aspect, a method is provided. The method includes receiving a first transaction for updating a first table and a second transaction for updating a second table. The first and the second table being respectively associated with a first and second policy. The method further includes generating a first queue indicating the first transaction and a second queue indicating the second transaction. The method further includes receiving from a set of replica nodes information indicating a status of each replica with respect to the first transaction and the second transaction. The method further includes determining that at least one of policies is satisfied based on the received information and committing one of the transactions based on the determining

### CROSS-REFERENCE TO RELATED APPLICATIONS

This is the first application filed for the present invention.

### FIELD OF THE INVENTION

The present invention pertains to the field of database support, and in particular to methods and systems related to a unified framework for global table with guarantee on replica data freshness.

### BACKGROUND

Existing databases may provide limited level of database support. Existing techniques, such as Paxos/RAFT groups, used for providing database support may not be flexible enough to adequately and efficiently accommodate various levels of database support that may be required. Existing implementation may involve putting data in dedicated Paxos/RAFT groups which may pose limitations and cause inadequate service. For example, a request to move data from one group to another, or to remove a group altogether, may involve performing lots of operations in the background, such as substantial copying of data, which in some cases, may cause potential non-availability of or disruption to data.

Therefore, improvements in the field of data protection against physical disasters are desirable.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides methods, systems and apparatuses related to a unified framework for global table with guarantee on replica data freshness. According to a first aspect, a method is provided. The method may be performed by a primary node of a distributed database. The method includes receiving a first transaction to update a first table of the distributed database. The first table being associated with a first policy according to which the first transaction is to commit. The method further includes generating a first queue associated with the first table, the first queue indicating the first transaction. The method further includes, receiving a second transaction to update a second table of the distributed database. The second table being associated with a second policy according to which the second transaction is to commit, and the second policy being different than the first policy. The method further includes generating a second queue associated with the second table, the second queue indicating the second transaction. The method further includes receiving, from a set of replica nodes of the distributed database, data indicating a status of the set of replica nodes with respect to one or more of: the first transaction and the second transaction. The method further includes determining that at least one of the first policy and the second policy is satisfied based on the received data, to obtain a determination. The method further includes committing at least one of the first transaction and the second transaction based on the determination.

In some aspects, each of the first policy and the second policy is based on a flushed log sequence number (LSN) at one or more replica nodes of the set of replica nodes. In some aspects, receiving data includes receiving from each of the set of replica nodes the data indicating a flushed LSN at said each replica node.

In some aspects, generating the first queue includes indicating the first transaction via a first LSN, and generating the second queue includes indicating the second transaction via a second LSN.

In some aspect, indicating the first transaction includes indicating the first transactions via the first LSN associated with a last update of the first transaction. In some aspects, indicating the second transaction includes indicating the second transaction via the second LSN associated with a last update of the second transaction.

In some aspects, each of the first policy and the second policy is based on one or more of: a flushed log sequence number (LSN) at a first subset of the set of replica nodes; an applied LSN at a second subset of the set of replica nodes; and an applied transaction timestamp at a third subset of the set of replica nodes.

In some aspects, receiving data includes receiving from each of the set of replica nodes the data indicating one or more of: a flushed LSN, an applied LSN, and an applied transaction timestamp. In some aspects, generating the first queue includes indicating the first transaction via one of: a first LSN and a first transaction timestamp. In some aspects, generating the second queue includes indicating the second transaction via one of: a second LSN and a second transaction timestamp.

In some aspects, the method further includes creating the first table. In some aspects, the method further includes assigning the first policy to the first table. In some aspects, assigning the first policy to the first table includes updating metadata of the first table to indicate the first policy.

In some aspects, the method further includes creating, by the primary node, the second table, and assigning the second policy to the first table. In some aspects, the method further includes modifying the first table's policy to obtain a third policy. In some aspects, modifying the first table's policy includes updating the metadata of the first table to indicate the third policy.

In some aspects, the method further includes receiving, by the primary node, a third transaction to update the first table, the third transaction is to commit according to the third policy. In some aspects, the method further includes generating a third queue associated with the first table, the third queue indicating the third transaction

According to another aspect, an apparatus is provided. The apparatus includes modules configured to perform the methods according to one or more aspects.

According to another aspect, another apparatus is provided, where the apparatus includes: a memory, configured to store a program; a processor, configured to execute the program stored in the memory, and when the program stored in the memory is executed, the processor is configured to perform the methods according to one or more aspects.

According to another aspect, a computer readable medium is provided, where the computer readable medium stores program code executed by a device, and the program code is used to perform the methods according to one or more aspects.

According to another aspect, a chip is provided, where the chip includes a processor and a data interface, and the processor reads, by using the data interface, an instruction stored in a memory, to perform the methods according to one or more aspects.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a geographically distributed database.

FIG. 2 illustrates another example of a geographically distributed database.

FIG. 3 illustrates an enhanced geographically distributed database, according to an aspect.

FIG. 4 illustrates a global-based and quorum-based implementation of an enhanced distributed database, according to an aspect.

FIG. 5 illustrates an example of a quorum-based support implementation, according to an aspect.

FIG. 6 illustrates an example of multiple levels of support, according to an aspect.

FIG. 7 illustrates another example of multiple level of support, according to an aspect.

FIG. 8 illustrates method for providing multiple levels of database support, according to an aspect.

FIG. 9 is a schematic diagram of an apparatus that may perform any or all of operations of the above methods and features explicitly or implicitly described herein, according to different embodiments of the present invention.

It will be noted that throughout the appended drawings, like features are identified by like reference numerals.

### DETAILED DESCRIPTION

Existing databases provide limited database support, as mentioned above. Further, existing databases lack flexibility to efficiently modify a level of support provided to a table. According to an aspect, a method is provided which may allow for different levels of database support. The database support may be based on one or more of: data availability and data freshness. The method may be performed at a primary node of a distributed database. In an aspect, the method includes receiving a first transaction to update a first table of the distributed database. The first table having a first policy according to which the first transaction is to commit. The first policy refers to a first level of database support. Thus, the first table may be assigned a first level of database support, which may be done by updating the metadata of the first table. The method further includes receiving a second transaction to update a second table of the distributed database. The second table having a second policy according to which the second transaction is to commit. The second policy refers to a second level of database support that is different than the first level of database support. The second table maybe assigned the second level of database support by updating the metadata of the second table. The method further includes generating a second queue associated with the second table, the second queue indicating the second transaction. The method further includes receiving, from a set of replica nodes of the distributed database, data indicating a status of the set of replica nodes with respect to one or more of: the first transaction and the second transaction. The method further includes determining that at least one of the first policy and the second policy is satisfied based on the received data, to obtain a determination. The method further includes committing at least one of the first transaction and the second transaction based on the determination. Accordingly, the method may provide for different levels of database support (e.g., the first policy and the second policy).

In an aspect, the method may allow for modifying the level of support provided to a table in an efficient manner. For example, the method may further include updating the metadata of the first table to indicate a third policy, which may refer to a third level of database support. Thus, modification of level of support provided to a table may be done more efficiently.

A geographically distributed database includes multiple machines or nodes located in multiple sites. In a geographically distributed database, data can first be distributed into multiple shards, by hash value or by a range of certain key values. Each shard can have a primary site (or primary node) and one or more replicas or standby sites (or replica nodes) that are replicas of the primary site. Each primary site can accept one or more WRITE operation requests.

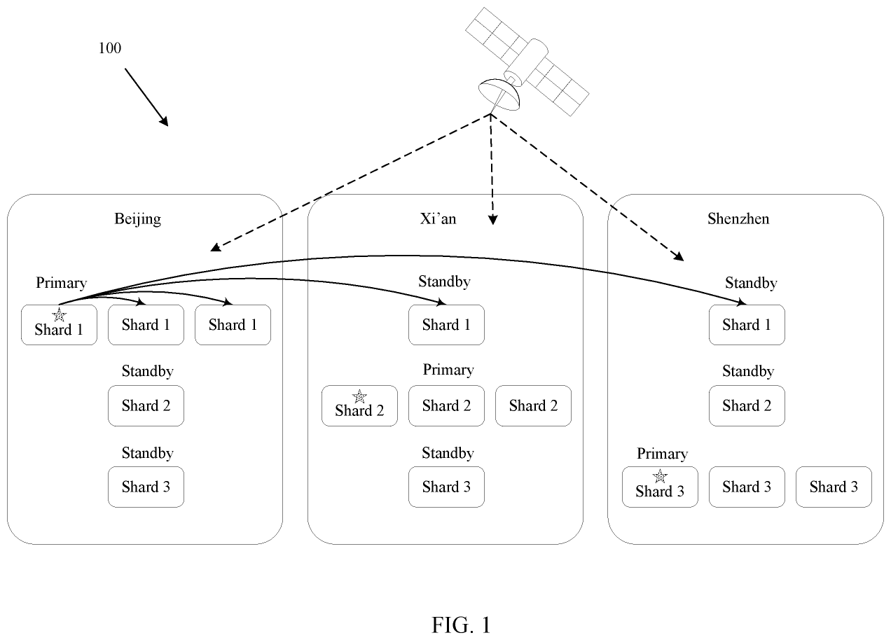

FIG. 1 illustrates an example of a geographically distributed database (or database) 100. The database 100 can span one or more cities, e.g., Beijing, Xi'an and Shenzhen as illustrated. Each table in the database 100 can be distributed into three primary shards by either hashing or range partitions. Each primary shard can have one primary (indicated via a star) and four replicas (also known as standbys). As illustrated, two of the replicas can be located in the same city as the primary, while the other two replicas can be located in other remote cities.

When a WRITE operation is performed on a table's data, the database 100 can determine which shard the data belongs to, and where the primary shard is located. Then, the WRITE operation can be applied on the determined primary shard. Thereafter, an appropriate number of REDO records can be generated based on the WRITE operation and propagated to the local and remote standbys (replicas).

REDO logs (comprising of REDO records), once arrived at a replica, can be applied on the replica in the order generated from the primary. Once a replica applies all REDO logs received from its corresponding primary, the replica is assumed to have identical data as the primary.

Geographically distributed databases, such as the database 100 of FIG. 1, may require different levels of disaster support. In some cases, a customer may require a level of regional disaster support for data categorized as important, such that the data survives a regional disaster (e.g., an earthquake). Such a level of support can be implemented by replicating the data across multiple regions. To provide or implement such a level of support, a transaction that inserts or updates such important information may require all its REDO logs replicated to remote regions before it can commit. Thus, due to the time needed for replicating, such a level of support may require some time before the transaction can commit. In some aspects a transaction may refer to an operation that involves multiple queries and updates to data in a database.

REDO logs may refer to updates of a transaction that may be translated to many small pieces of delta information. Such delta information may be referred to as REDO records, which may be streamed to a log at disk, and also streamed from primary nodes to one or more replica nodes. The one or more replicas may need to apply such REDO logs received from the primary to ensure that its data is consistent with the data at primary.

As may be appreciated by a person skilled in the art, an operation (e.g., a WRITE operation) generates REDO records, such REDO records will be inserted into a single stream. Each REDO record may thus be identified by an offset the REDO record was placed in the stream. In some aspects, the offset may be called a log sequence number. In some aspects, the LSN may be monotonously increasing as REDO records are generated and placed into the stream.

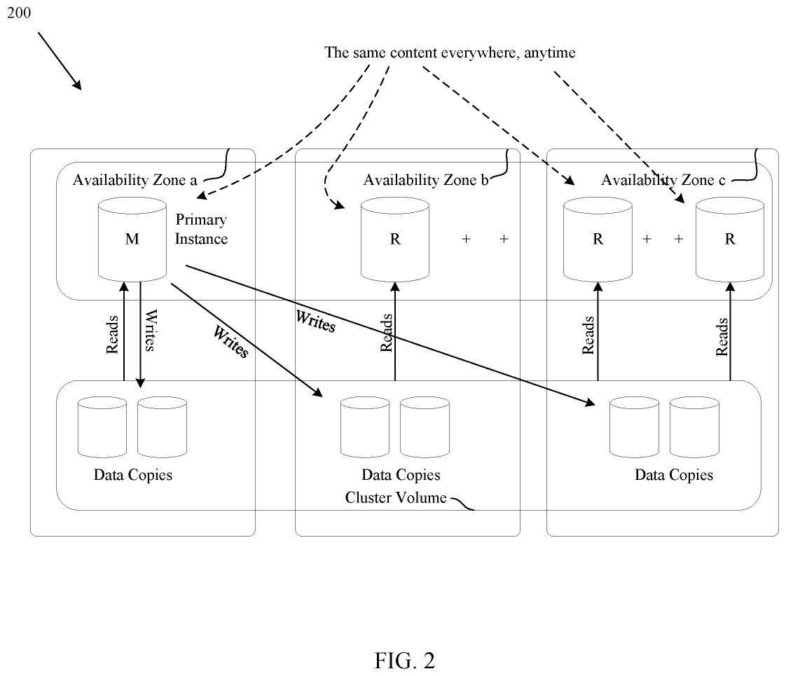

FIG. 2 illustrates another example of a geographically distributed database 200. The geographically distributed database 200 may span across zones a, b and c. The primary instance M can be at zone a, and the replicas Rs can be in zone b and c as illustrated. To accommodate a support level that prevents loss of data during a regional disaster, a WRITE operation may commit once the WRITE operation is performed at the primary (zone a) and all replicas (zones b and c). Such a commit time (i.e., after data is replicated in all replicas) may also provide a data freshness level such that same content is available everywhere at any time.

However, not all data need the same level of support. In some instances, a faster transaction commit time may be more desirable, which may not be available if a transaction commits only after all REDO logs are replicated to remote regions. Thus, for a faster transaction commit time, a database, according to an aspect, can be configured such that transactions can commit before all REDO logs are replicated to remote regions (i.e., no need to wait for REDO logs to replicate to remote regions).

Therefore, a geographically distributed database that can accommodate different levels of support is desirable. For example, in an aspect, the geographically distributed database may provide for regional disaster support for important data (which may involve slower operations). In other aspects, the geographically distributed database may provide for improved performance (e.g., improved transaction commit time) with some loss to less important data during a regional disaster.

It is further desirable for a geographically distribute database to accommodate different levels of data freshness at remote replicas. For example, some customers may require that any updates to important data be visible anywhere (e.g., anywhere in the world) once the WRITE operation is finished. Such requirement can be implemented by having WRITE operations wait until its REDO logs are replicated to remote replicas all over the world, and further wait until such REDO logs are applied on all remote replicas. Such a level of data freshness may not be needed by all customers. For example, some customers may not require all data to be fresh anywhere at any time. These customers, thus, do not need to incur the extra costs of waiting per WRITE operation for all data to be fresh anywhere at any time.

Existing databases currently lack the capability to support multiple levels of disaster support and data freshness support at the same time. Although some database vendors claim to support different levels of disaster, their implementation is based on multiple Paxos/Raft replication groups. Paxos/RAFT refers to techniques used to replicate data from primary to participating replica machines and ensures some level of RPO requirement with disruptions any time at any site.

These vendors' implementation involves putting all important data into one mission-critical Paxos/RAFT group and the rest not-so-important data into another less critical Paxos/RAFT group. The mission-critical Paxos/RAFT group may be stored in machines across multiple regions, thereby minimizing the chance of losing data during a local regional failure. When the data, being held in mission-critical Paxos/RAFT group, no longer needs regional disaster protection, the data may be moved from the mission-critical Paxos/RAFT group to a less mission-critical Paxos/RAFT group. This moving of data may involve substantial copying, which may cause the data to be offline for a period of time.

Some aspects of the disclosure may provide for methods and systems for supporting multiple levels of disaster support and data freshness support at the same time. Some aspects may provide for altering the level of support (or switching between different levels of support) with reduced or no bulk data movement. In some aspects, the switching between different levels of support may be done without interrupting the availability of the data (i.e., switching may be done on the fly or quickly). Some aspects may provide for a flexible level of support, accommodating various levels of freshness and disaster recovery requirements.

Some aspects of the disclosure may provide for a framework that supports different levels of freshness guarantees and different levels of data availability. Data freshness may refer to the recency of data when READ or how up-to-date the data may be in replicas compared to the primary. For example, one level of data freshness guarantee may indicate that replicas have the same data as primary at the same time for READs. Another level of data freshness guarantee may indicate that the replicas do not have the same data as the primary at the same time for READs.

Data availability may refer to the survivability of data or the risk of data loss after a disruption or a data-loss incident (e.g., a machine, site or region disaster). Data availability may be indicated via a recovery point object (RPO). An RPO may refer to the amount or quantity of data lost during a disruption. An RPO=0 for disruptions such as earthquake, building power failure, or machine breakdown may indicate that no data may be lost for such disruptions.

Some aspects of the disclosure may provide for a framework that supports various levels of RPO requirements at one or more disaster levels (e.g., at site level, region level, building level and the like). Some aspects of the disclosure may additionally provide for various levels of data freshness guarantee. Some aspects of the disclosure may provide for dynamic switching of the level of support.

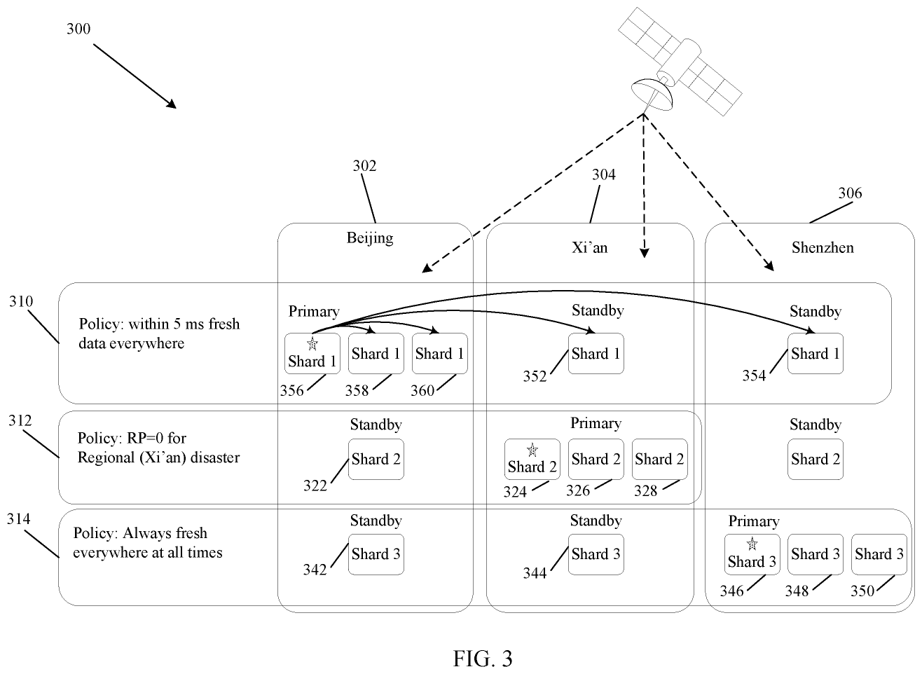

Some aspects of the disclosure may provide for an enhanced distributed database 300 that can offer a customized support at table level. FIG. 3 illustrates an enhanced geographically distributed database, according to an aspect of the present disclosure. In an aspect, the enhanced geographically distributed database (or database) 300 can span one or more locations, e.g., Beijing 302, Xi'an 304, and Shenzhen 306.

In some aspects, the database 300 can provide a customized support at table level. For example, one or more tables (e.g., table 312) in the database 300 can be customized to survive a regional disaster (e.g., RP=0 for a disaster in Xi'an). As illustrated, table 312, which may be associated with shared 2, may be configured to have its data replicated in at least one remote region (e.g., in Beijing 302, remote shard 2 322) in addition to its primary region (e.g., Xi'an 304, which includes a primary shard 2 324, and two replica shard 2s 326 and 328). Accordingly, a regional disaster in Xi'an 304 may not affect the replicated data stored in Beijing 302 shard 2 322.

In addition to regional disaster support, in some aspects, database 300 may provide for table support based on site or machine disaster. For example, at least one copy of table 312, at a different site (e.g., any one local replica shard 2 (e.g., 326 or 328) or a remote replica shard 2 322) other than the primary site, may be needed to provide site disaster support. As may be appreciated by a person skilled in the art, the at least one copy of table 312 (at a replica) for site disaster support need not to be limited to the primary's region (e.g., Xi'an), and can be at any other region. Accordingly, any site disaster to the primary shard 2 in Xi'an may not cause any data loss at the replica (e.g., any one local replica shard 2 (e.g., 326 or 328) or a remote replica shard 2 322), thereby providing a site disaster support. A person skilled in the art may appreciate that any combination of site, region or other notations associated with a geographical area, disruption, disaster, and the like may be considered to determine a level of disaster support.

In some aspects, database 300 may provide for a level of support such that a table (e.g., table 314) may have identical data at all replicas (e.g., remote shard 3s 342 and 344, and local shard 3s 348 and 350) in addition to the primary shard 346 at all times (e.g., a global table where data is always fresh, everywhere). In some aspects, database 300 may provide for a level of support such that a table may or may not have identical data at one or more replicas at all times. In some aspects, database 300 may provide for a level of support such that a table (e.g., table 310) may have its data at one or more replicas (e.g., remote shard is 352 and 354, and local shard is 358 and 360) to be within a certain time (e.g., 5 milliseconds) older than the tables' data at the primary (e.g., shard 1 356), at any time. For example, database support can be based on a transaction committing after the transaction has replayed within a certain time (e.g., x-milliseconds) on all replica sites. As may be appreciated by a person skilled in the art, the extent (e.g., the number of replicas) and degree of data freshness may vary, and so can the corresponding level of support that the database 300 may provide.

In an aspect, level of support can be based on one or more of: a certain number of data base nodes, and a geographical area coverage. So, for example, to provide a regional disaster support, a transaction can commit once a remote replica at a different region than the primary has replicated the transaction. In some aspects, database support can be based on a quorum of database nodes such that a transaction commits after a quorum of database nodes has received or applied all the REDO logs of the transactions. In some aspects, a quorum can include one or more remote sites.

In some aspects, database support can be based a transaction committing after all standbys or all database nodes have replayed the transaction (e.g., a global table). As may be appreciated by a person skilled in the art, to replay a transaction may refer to a standby having received the REDO logs or updates made at the primary and having applied such REDO logs or updates.

In some aspects, the database 300 may provide for modifying the level of support at a table. For example, database 300 may be configured to modify table 312's support level to that of table 314. Thus, table 312's regional disaster support can be modified to provide for a global support having an always fresh at all time status. In some aspects, the modification of table's level of support may be done with limited or no offline time.

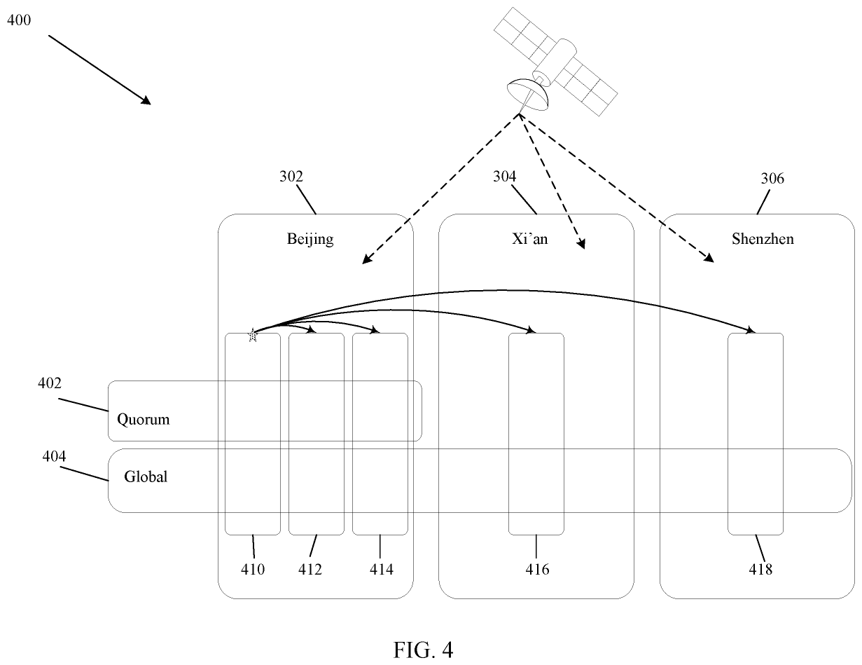

FIG. 4 illustrates a global-based and quorum-based implementation of an enhanced distributed database, according to an aspect. In an aspect, the database 300 may comprise a primary node 410 and four replica nodes (two local 412 and 414 and two remote 416 and 418). In a typical quorum-based implementation 402, a transaction may commit when a quorum (majority nodes) flushes REDO log to disk. As illustrated, the quorum does not need not to, but may, include a remote site. The quorum-based implementation may provide for a site or machine failure support at 302, since the transaction commits once the two nearest replicas has flushed REDO log to disk.

In a global-based implementation 404 (global table), a transaction may commit when all replicas have applied REDO logs of the transaction. As may be appreciated by a person skilled in the art, the transaction commit time for a global-based implementation may be longer than the transaction commit time for a quorum-based implementation.

Thus, the type of implementation may reflect a level of database support. In an aspect, to provide a global support to a table, its metadata indicate that the table is as global, indicating that a transaction associated with the table is based on a global-based implementation, i.e., the transaction commits after all replicas have replayed the transaction. Similarly, to provide a regional support to a table, the table's metadata may indicate that a transaction associated with the table commits once at least one replica, in a region different from the primary, has replayed the transactions. In an aspect, specifying the level of support for a table may be done at the creation time, further described herein elsewhere.

Some aspects may provide for altering the level of the database support provided to a table (or switching between different levels of database support). In an aspect, the switching from a global support to a regional-disaster support of a table can be based on modifying the table's metadata to indicate the new level of support.

Some aspects of the disclosure may provide for a framework (e.g., an enhanced geographically distributed database 300 or 400) that provides for various levels of support in terms of data availability (e.g., disaster support) and data freshness. In some aspects, a database can be configured to have one or more WRITE operations wait until one or more of: data is replicated to one or more replicas, and data is applied to one or more replicas, wherein the one or more replicas may be local or remote.

In some aspects, a database may be configured to have one or more WRITE operations wait until data is replicated to local replicas or all remote replicas. In some aspects, a database may be configured to have one or more WRITE operations wait until REDO logs of the operations are applied to all replicas.

In an aspect, a level database support provided to a table may be indicated via or based on a policy. For example, a regional disaster level of support may be indicated via a policy such that a transaction commits only if a remote replica has received the updates (e.g., REDO records) associated with the transaction. Similarly, a global support level may be based on a policy indicating that a transaction commits only when all replicas have replayed the updates associated with the transaction. Accordingly, each level of support can be based on a policy indicating the requirement for transaction commitment.

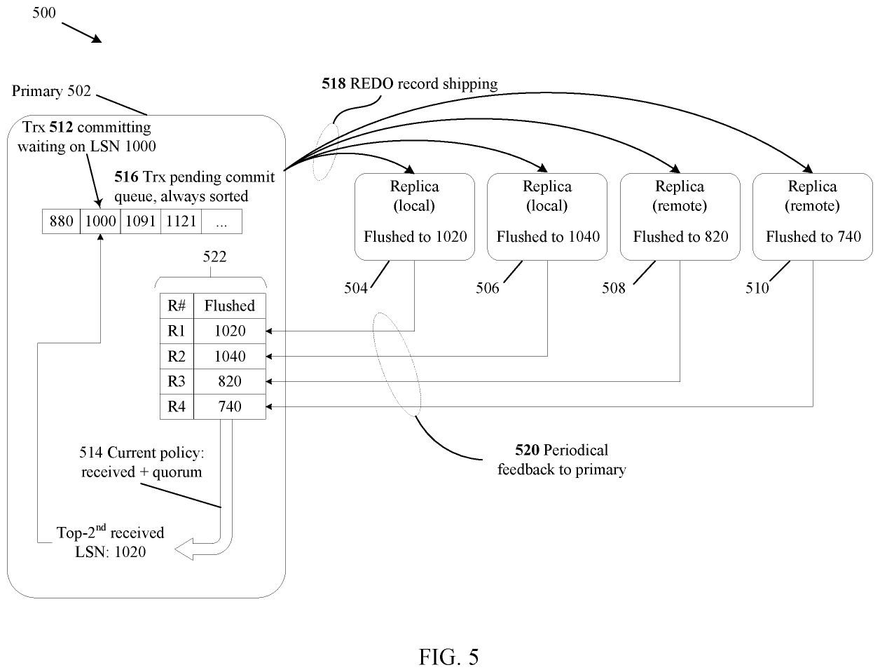

FIG. 5 illustrates an example of a quorum-based support implementation, according to an aspect. Referring to FIG. 5, the database 500 may be similar to the database 400 or 300. Database 500 may comprise a primary node 502 and four replica nodes, two of which are local 504 and 506, and the other two are remote 508 and 510. In some aspects, the local replica nodes 504 and 506 may be in the same building as the primary node 502, whereas the two remote replica nodes 508 and 510 may be in remote cities.

In an aspect, the database 500 may be configured to commit a transaction if its REDO records have been received by a majority number of nodes in the cluster. For example, if two replica nodes have received all the REDO records of a transaction from the primary node 502, then three copies of the data may exist across the cluster, thereby forming a majority (quorum) out of all five nodes. Once such a quorum is reached, the transaction can be marked as finished. In a quorum-based implementation, if any minority number of nodes breakdown, the data will survive since a majority of the database nodes have a copy of the data. Thus, the quorum-based implementation may be viewed as a level of database support which can be indicated by a policy according to which the associated transactions commit.

In an aspect, a transaction 512 may be received for updating a table that is associated with a quorum-based policy 514. For example, the policy 514 may indicate that transaction 512 commits when a quorum of the database nodes have received the updates (or REDO records) associated with the transactions.

Accordingly, in an aspect, the transaction 512 at the primary 502 may be placed into a queue 516. For example, the transaction 512 may be indicated in the queue 516 via the log sequence number (LSN) of the last REDO record of the transaction 516 as its representative. As illustrated, the LSN of the last REDO record of the transaction 516 is 1000. The queue 516 may be associated with the policy 514 such that the transactions on the queue 516 may commit according to the policy 514.

Meanwhile, the REDO records of the transactions, including transaction 512, may be streamed or shipped 518 simultaneously to all replicas. The replicas may periodically reply 520 to the primary with information or data indicating a “Received LSN” (or “Flushed LSN”). The Received LSN, indicates up to which LSN the replicas have received the REDO records from the primary. These replies 520 may be gathered at the primary and sorted into replica feedback slots 522.

In some aspects, some replicas may receive more REDO records than other remote replicas. In the illustrated example, the local replicas 504 and 506 have received more REDO records than the remote replicas 508 and 510, thus the local replicas 504 and 506 have larger “Received LSN” compared to the remote replicas in the feedback slot 522.

In some aspects, the primary node 502 may sort the “Received LSN” in the feedback slots 522 according to an appropriate procedure, which may be based on the policy. For example, the queue 516 including the transaction 512 may be based on the policy 514 which requires a quorum of database nodes to have flushed the last REDO record of a transaction, for the transaction to commit. Accordingly, the primary node 502 may sort the “Received LSN” to determine up to what LSN has a quorum flushed.

In the illustrated example, four replicas are involved, thus, two replicas in addition to the primary forms a quorum (majority). Thus, to comply with the policy, the top-second flushed LSN (because two replicas in addition to the primary form a quorum) from the fed back flushed information or data can serve as the indicator up to which point in the log stream (e.g., up to what LSN) has a quorum flushed.

The second largest LSN in the feedback slot may then be used, by the primary node, to poke (trigger) the queue 516, and wake up or unlock any transaction that waits on equal or smaller LSN. Thus, all transactions up to the indicated quorum-based flushed LSN (the second largest LSN in the feedback slot) can be notified for commitment. Commitment based on the policy 514 as described may ensure that all REDO logs of the committed transactions are saved on a quorum-basis.

In the illustrated example, the top second flushed LSN (referring to replica 504) indicate an LSN of 1020. Thus, all transactions associated with LSN of up to 1020 can be notified for commitment. Based on the queue 516, transactions up to transaction 512 (LSN 1000) can be notified for commitment.

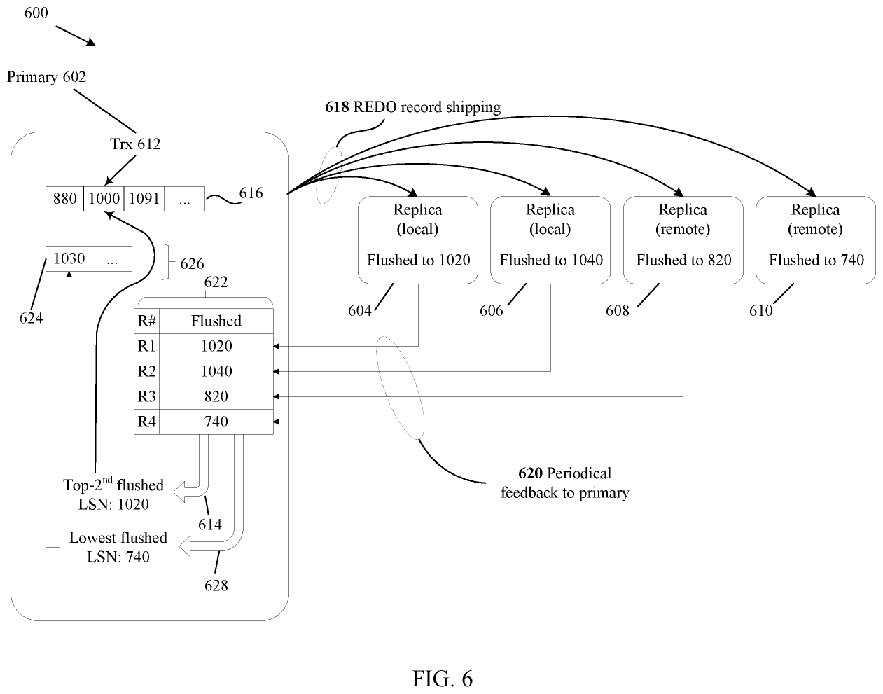

FIG. 6 illustrates an example of multiple levels of support, according to an aspect. The database 600 may be similar to database 500. Database 600 may comprise a primary node 602, two local replica nodes 604 and 606, and two remote replica nodes 608 and 610.

In an aspect, a transaction 612 may be received for updating a first table of the database 600. The first table may be customized to be provided with a quorum-based support. Thus, the first table may be associated with a first policy 614 which may require a quorum of the database nodes to have flushed all REDO logs of a transaction for the transaction to commit. The transaction 612 may be placed in a first queue 616 generated for the first table. The transaction 612 may be indicated on the queue 616 via an LSN (e.g., LSN 1000) associated with the last REDO record of the transaction 612. The queue 616 may be associated with the first policy 614 such that the transactions on the queue 616 may commit according to the first policy 614. In an aspect, Queue 616 and policy 614 may be similar to the queue 516 and policy 514 respectively.

Similar to FIG. 5, the REDO records of the transactions, including transaction 612 and 624, may be streamed or shipped 618 simultaneously to all replicas. The replicas may periodically reply 620 to the primary with information or data indicating a “Received LSN” (or “Flushed LSN”).

When a quorum of database has flushed up to or more than LSN 1000, then transaction 612 may be notified for commitment. In the illustrated example, the received flushed information indicate that the top-second received LSN is 1020, which is greater than the last REDO record of transaction 612. Accordingly, the first policy is satisfied based on the received LSN information for the transaction 612, and thus transaction 612 can commit.

In one aspect, a second transaction 624 may be received for updating a second table of the database 600. The second table may be customized to be provided with a second policy 628. The second policy may require all replicas to have received or flushed the REDO records of the transaction for the transaction to commit. The second policy may be based on, for example, the second table surviving a geographical disaster (i.e., the primary, and two local replicas all fail, yet still no data loss).

In an aspect, the transaction 624 may be placed in a second queue 626 generated for the second table. The transaction 624 may be indicated on the queue 626 via an LSN (e.g., LSN 1030) associated with the last REDO record of the transaction 624. The second queue 626 may be associated with the second policy 628 such that
the transactions on the queue 626 may commit according to the second policy 628. To determine which transactions in queue 626 may be committed, the feedback information or data including the received LSN may be evaluated. Since the second policy require all replicas to have received the REDO records, then the lowest received LSN may be used, by the primary node, to determine which transactions in queue 626 may be committed. Based on the illustrated example, the lowest flushed LSN is 740 associated with the replica node 610. Accordingly, transaction 624 should not yet commit and wait until the lowest flushed LSN reaches at least an LSN of 1030. Transactions in queue 626 may thus commit according to the second policy to ensure that data survive a geographical disaster.

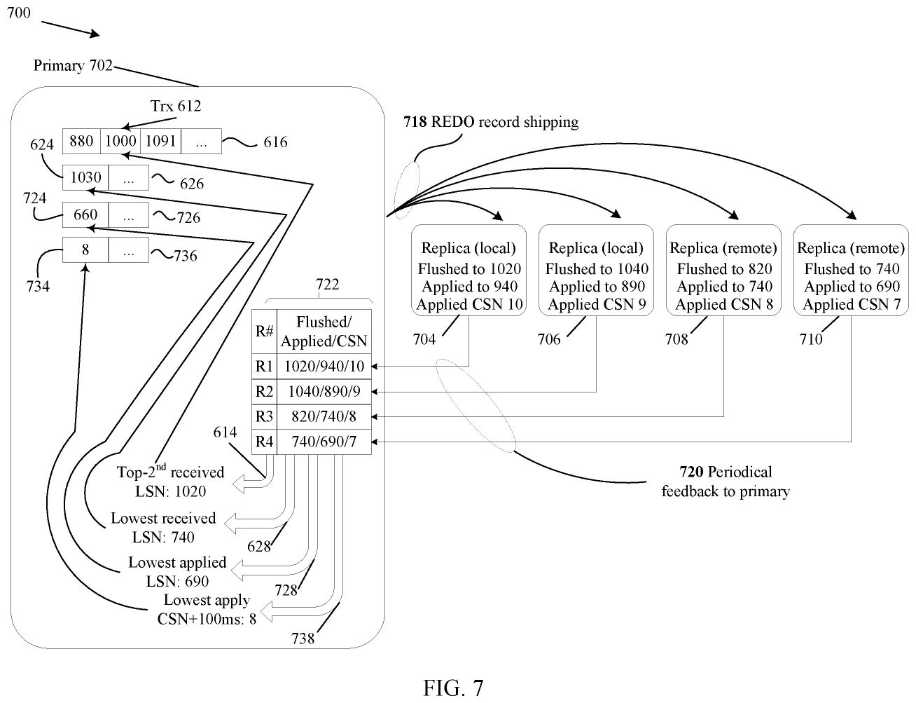

FIG. 7 illustrates another example of multiple level of support, according to an aspect. Database 700 may be similar to database 600. Database 700 may comprise a primary node 702, two local replica nodes 704 and 706, and two remote replica nodes 708 and 710.

In an aspect, database 700 may receive one or more transactions for updating one or more tables, wherein each table may be associated with a corresponding policy according to which the associated transactions are to commit.

For example, database 700, may receive one or more of: transactions 612, 624, 724, and 734. Meanwhile, the primary mode may stream or ship 718 the one or more transactions' REDO records to the replicas. Similar to FIGS. 5 and 6, the replicas may periodically reply 720 to the primary with information or data indicating one or more of: a “Received LSN” (or “Flushed LSN”), an applied LSN, and an applied CSN (Commit Sequence Number). A flushed LSN may indicate the number of bytes up to which a replica node or a standby has saved to disk, in the order they were saved to disk at the primary node. An applied LSN may indicate the number of bytes up to which a replica node has applied on its data pages or tables. An applied CSN may indicate, in terms of transaction timestamp based on a clock time, the extent up to which a replica has applied the transactions in the order they were committed on the primary node.

Regarding transactions 612 and 624 and their corresponding tables and policies, database 700 may perform operations similar to that of database 600 including generating queues (616, 626), receiving information or data including flushed LSN, from the replicas, and notifying the transactions for commitment based on their corresponding policy and the received flushed LSN.

In an aspect, transaction 724 may indicate an update to a third table which may be associated with a third policy 728. The third policy 728 may be based on a database support that requires all replicas to have applied the updates or REDO records. For example, the third table may refer to a customer requirement that data be always fresh, everywhere. Thus, the third policy 728 may be set to ensure that the transaction commits only after all replicas have applied the transaction's REDO records.

In an aspect, transaction 724 may be placed in a third queue 726 generated for the third table. The transaction 724 may be indicated on the queue 726 via an LSN (e.g., LSN 660) associated with the last REDO record of the transaction 724. The third queue 726 may be associated with the third policy 728 such that the transactions on the third queue 726 may commit according to the third policy 728.

In an aspect, each replica may be configured to provide 720, in addition to information indicating a flushed LSN, information indicating an applied LSN. As may be appreciated by a person skilled in the art, information indicating an applied LSN may represent up to which REDO record a replica has applied on its own data. Thus, if a replica has applied all REDO records from its corresponding primary, then the replica may have the same data as the primary. If a replica has replayed up to a certain LSN, then the replica may be consistent with the primary, up to any transactions that waits upon equal to or smaller than the certain LSN.

The primary node 702 may sort the information or data received, including one or more of: flushed LSN and applied LSN, to determine, according to one or more policies, which transaction may be notified for commitment. With respect to transaction 724, the primary node may determine the minimum applied LSN from the feedback slot 722 to determine which transactions may be notified for commitment.

In the illustrated example, the feedback information or data 722 indicate that all replicas have applied up to a LSN of 690 (based on the lowest applied LSN which refers to replica 710).

Accordingly, all transactions in the queue 726 up to LSN 690 can be notified for commitment. Since transaction 724 is indicated via an LSN of 660, transaction 724 may be waken up or unblocked because according to the feedback information or data, all REDO records of the transaction 724 has been applied on all replicas, and thus the data is fresh everywhere.

In an aspect, transaction 734 may indicate an update to a fourth table which may be associated with a fourth policy 738. The fourth policy 738 may be based on a bounded staleness level, such that a transaction commits at a certain period (e.g., 100 milliseconds) after all replicas have applied. Accordingly, in an aspect, each replica may include in their feedback a transaction timestamp (e.g., according to a global clock) indicating a freshness level compared to the primary.

As may be appreciated by a person skilled in the art, each transaction at the primary may be associated with a timestamp. When a transaction commits, a timestamp (e.g., according to a global clock) may be associated with the transaction. The timestamp may be translated back to a real time. In an aspect, each replica may feedback a timestamp relative to the timestamp of the primary, indicating a level of data freshness.

Each replica may feedback its applied transaction timestamp. The applied transaction timestamp may be in a form of a transaction commit number, for example, an applied CSN, referring to a global clock. While each replica is applying the REDO logs, the replica may also be aware of the latest or the biggest transaction timestamp (e.g., applied CSN).

In an aspect, transaction 734 may be placed in a fourth queue 736 generated for the fourth table. The transaction 734 may be indicated on the queue 736 via a transaction timestamp (e.g., according to a global clock). The fourth queue 736 may be associated with the fourth policy 738 such that the transactions on the fourth queue 736 may commit according to the fourth policy 738.

In an aspect, after sorting the feedback information or data 722, including one or more of: flushed LSN, applied LSN, and applied CSN, the primary node may determine which transactions may be notified for commitment. In the illustrated example, the feedback information indicates that lowest applied CSN is 7 referring to replica 710. Based on feedback information and policy 738, the primary node 702 may determine whether to notify transaction 734 to commit. For example, transaction 734 is indicated by applied CSN of 8 in the generated queue 736, and the policy 738 indicates that for queue 736, the transactions commit based on the lowest applied CSN. The lowest applied CSN as fed back by the replicas is indicated to be 7 (referring to replica 710). Thus, transactions 734 has to wait until the lowest applied CSN (which in the illustrated example would be replica 710) is 8, before notifying transaction 734 to commit.

As may be appreciated by a person skilled in the art, the policy 738 may be based on a bounded staleness, in which 100 ms may be added to the lowest applied CSN. In an aspect, CSN may refer to a transaction timestamp based on a clock time such that arithmetic operations may be performed on the CSN with a delta of time. In an aspect, 1 unit in CSN may correspond to 100 ms, such that a received applied CSN of 7, at replica 710, may indicate that the transactions applied at replica 710 lag 100 ms (1 CSN) from the transaction 734, indicated via CSN 8. Thus, transaction 734 may be notified once the lowest applied CSN is 8.

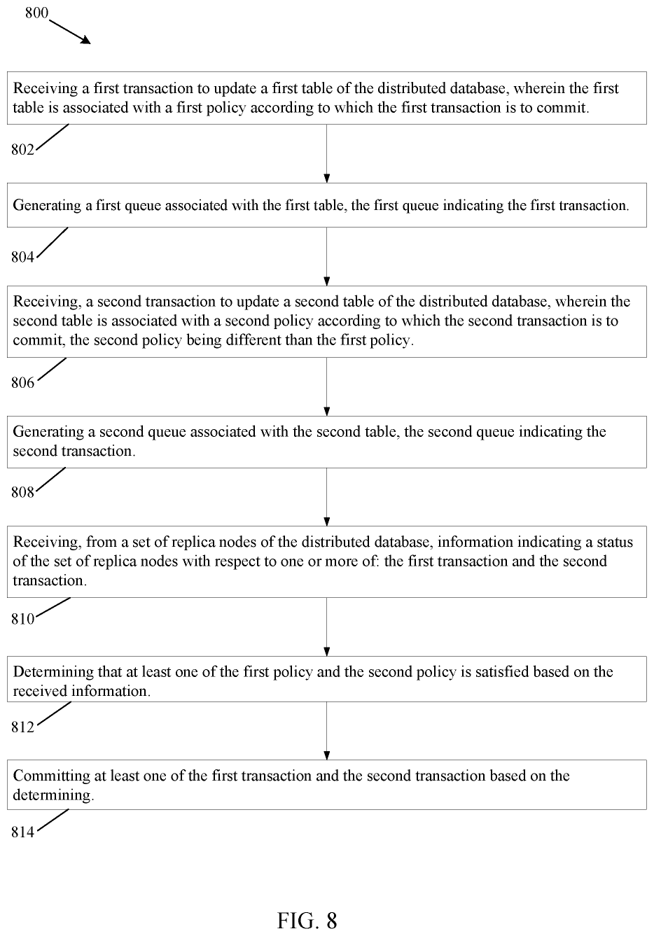

FIG. 8 illustrates a flowchart of a method for providing multiple levels of database support, according to an aspect. The method 800 may be performed by a primary node of a distributed database. In an aspect, the method 800 may comprise receiving 802, a first transaction to update a first table of the distributed database, wherein the first table is associated with a first policy according to which the first transaction is to commit.

The method 800 may further comprise generating 806 a first queue associated with the first table, the first queue indicating the first transaction. The method 800 may further comprise, receiving 808, a second transaction to update a second table of the distributed database, wherein the second table is associated with a second policy according to which the second transaction is to commit, the second policy being different than the first policy.

The method 800 may further comprise, generating 808 a second queue associated with the second table, the second queue indicating the second transaction. The method 800 may further comprise receiving 810, from a set of replica nodes of the distributed database, information or data indicating a status of the set of replica nodes with respect to one or more of: the first transaction and the second transaction.

The method 800 may further comprise, determining 812 that at least one of the first policy and the second policy is satisfied based on the received information or data. The method 800 may further comprise committing 814 at least one of the first transaction and the second transaction based on the determining.

In some aspects, each of the first policy and the second policy is based on a flushed log sequence number (LSN) at one or more replica nodes of the set of replica nodes. In some aspects, receiving information may comprise receiving from each of the set of replica nodes information or data indicating a flushed LSN at said each replica node.

In some aspects, generating a first queue comprises indicating the first transaction via a first LSN, and generating a second queue comprises indicating the second transaction via a second LSN.

In some aspect, indicating the first transaction comprising indicating the first transactions via the first LSN associated with a last update of the first transaction. In some aspects, indicating the second transaction comprises indicating the second transaction via the second LSN associated with a last update of the second transaction.

In some aspects, each of the first policy and the second policy is based on one or more of: a flushed log sequence number (LSN) at one or more replica nodes of the set of replica nodes, e.g., a first subset of the set of replica nodes; an applied LSN at one or more replica nodes of the set of replica nodes, e.g., a second subset of the set of replica nodes; and an applied transaction timestamp at one or more replica nodes of the set of replica nodes, e.g., a third subset of the set of replica nodes. In some aspects, the first subset, the second subset and the third subset may have replica nodes in common. In other aspects, only two of the three subsets may have replica nodes in common. In further aspects, the first subset, the second subset and the third subset may not have any replica node in common.

In some aspects, receiving information comprises receiving from each of the set of replica nodes information or data indicating one or more of: a flushed LSN, an applied LSN, and an applied transaction timestamp. In some aspects, generating a first queue comprises indicating the first transaction via one of: a first LSN and a first transaction timestamp. In some aspects, generating a second queue comprises indicating the second transaction via one of: a second LSN and a second transaction timestamp.

In some aspects, the method 800 may further comprises creating, by the primary node, the first table. In some aspects, the method 800 further comprises assigning, by the primary node, the first policy to the first table. In some aspects, assigning the first policy to the first table comprises updating the first table's metadata to indicate the first policy.

In some aspects, the method 800 may further comprise creating, by the primary node, the second table, and assigning, by the primary node, the second policy to the first table. In some aspects, the method 800 may further comprise modifying the first table's policy from the first policy to a third policy. In some aspects, modifying the first table's policy comprises updating the first table's metadata to indicate the third policy.

In some aspects, the method 800 may further comprise receiving, by the primary node, a third transactions to update the first table, the third transaction is to commit according to the third policy. In some aspects, the method 800 may further comprise generating a third queue associated with the first table, the third queue indicating the third transaction

As may be appreciated by a person skilled in art, various policies may be developed to reflect various support levels that may be provided to a table. The types of policies are not limited to the described aspects herein.

In some aspects, each of the one or more queues generated (e.g., ques 616, 626, 726, 736) may represent a different offset for different type of transaction. As may be appreciated by a person skilled in the art, all queues generated may refer to the same log stream such that each offset indicated in each queue refer to an offset in a single global log stream.

In some aspects, each transaction received may be placed in a queue generated according to a corresponding table and a corresponding policy. The transaction in the queue may be indicated based on information or data that is relevant for the corresponding policy. For example, if the corresponding policy is based on flushed or applied LSN, then the transaction in the corresponding queue may be indicated via an LSN associated with the transaction. If the corresponding policy is based on a time period (e.g., transaction is to commit at 100 milliseconds after all replicas have applied the REDO records), then the transaction in the corresponding queue may be indicated using an appropriate timestamp. A person skilled in the art may appreciate that various policies may be developed that reflect various levels of support for a data. Appropriate information may be used to indicate a transaction in a queue to allow for determining whether the transaction commits according to a corresponding policy.

Similarly, depending on the policy that is assigned to a table, relevant information or data may be received from the replica by the primary, to determine whether a transaction should commit according to the policy. A person skilled in the art may appreciate that, in some aspects, a transaction in a queue may commit independently of another transaction in a different queue since each que may be based on a different policy.

In an aspect, a table's metadata may be associated with a policy indicating the policy according to which associated transactions should commit. In some aspects, a table's policy may be modified or switched dynamically to another policy. For example, a table being associated with a first policy 614 (e.g., flushed LSN by a quorum of the database nodes) may then be switched to be associated with a second policy 628 (all replicas are to flush the REDO records). Changing a table's policy may done by updating or altering the table's metadata with the new policy.

Some aspects may provide for both multi-level disaster recovery and new data freshness requirement. Some aspects may additionally provide for new queues on the primary based on new policies, and new feedback data from the replicas as required. In some aspects, different types of transactions, at the primary node, may wait on different queues to fulfill different requirements.

Some aspects may provide for associating different objects to transactions so that the transactions may know which queue to wait upon. In some aspects, commitment of transactions with more stringent policies (referring to higher support level requirements) may not interfere with commitment of transactions waiting with less stringent requirement.

In an aspect, when a table is created, the associated policy (i.e., what disaster recovery level or what freshness guarantee the table may need) may be specified. For example, a table with a regional disaster support may be specified according to the following syntax:
CREATE/ALTER TABLE <xxx> WITH GLOBAL_SUPPORT

As may be appreciated by a person skilled in the art, a table may already have associated metadata in the database when the table is created. The associated metadata may include information indicating one or more of: number of columns, a value type for each column, etc. In an aspect, the associated metadata may be updated to include information indicative of a policy according to which one or more transactions for the table should commit. As described herein, the policy may include information indicating one or more of: a flushed LSN from one or more replicas, an Applied LSN from one or more replicas, an applied CSN from one or more replicas, or any other information which may be used for developing the policy.

In an aspect, the table may be altered, any time, to have a different level of support or policy. The level of support, whether specified at create time or altered at a later time, may be indicated by and stored at the table's metadata.

In an aspect, whenever a transaction indicates an update to such a such a table, the transaction may be tagged with the table's specification including the policy reflecting the level of support for the table. In some aspects, if a transaction indicates an update to multiple tables, the transaction may be tagged with the most restrictive policy.

According to an aspect, an order of one or more policies' restrictiveness, from highest to lowest may be as follows: first (highest restrictiveness): ANYWHERE, ANY TIME fresh; second: regional disaster support; and third (least restrictiveness): quorum support (most current vendor supports by default).

In an aspect a transaction may be placed in a corresponding queue until notified for commitment, where the commitment is based on a policy of database support and feedback information or data from replica nodes. In an aspect where a table is associated with a policy of always fresh table, a read transaction may have the option to read from a primary node or a remote node directly.

Some aspects of the disclosure may allow a customer to choose a level of support at CREATE table time, which may provide granularity at table level. Some aspects may provide support for both regional disaster-proof table and regular table (e.g., RPO=0 for earthquake, or normal site failure). Some aspects may support tables that are always fresh in every region (e.g., anytime fresh, anywhere).

Some aspects may provide for a framework that may be minimally intrusive to most existing database architecture. Some aspects may allow for dynamic changing of a table's level of support using “ALTER TABLE” command, with minimum offline time. Dynamic changing of a table's level of support may obviate the need to copy or move tables, as may be needed in existing techniques such as Paxos/RAFT group.

In some aspects, commitment of a transaction according to a first policy may be done independently of the commitment of prior transaction according to a second policy, provided no dependency exists between the two transactions.

As may be appreciated by a person skilled in the art, in some aspects, the methods and systems for providing multiple levels of database support may only need one REDO log stream between each primary and replica pair. Thereby, obviating the need for dedicated channel for REDO log replication for each level of support, as may be needed in existing techniques.

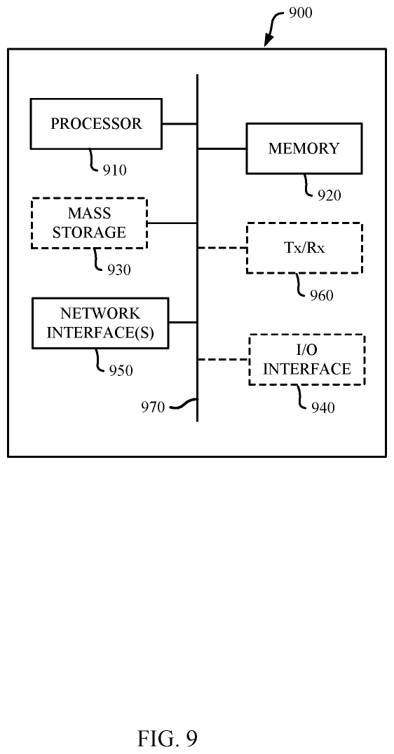

FIG. 9 is a schematic diagram of an apparatus 900 that may perform any or all of operations of the above methods and features explicitly or implicitly described herein, according to different embodiments of the present invention. For example, a computer equipped with network function may be configured as apparatus 900. In some embodiments, the apparatus may be a device that connects to the network infrastructure over a radio interface, such as a mobile phone, smart phone or other such device that may be classified as a user equipment (UE). In some embodiments, the apparatus 900 may be a Machine Type Communications (MTC) device (also referred to as a machine-to-machine (m2m) device), or another such device that may be categorized as a UE despite not providing a direct service to a user. In some references, an apparatus may also be referred to as a mobile device, a term intended to reflect devices that connect to mobile network, regardless of whether the device itself is designed for, or capable of, mobility. In some embodiments, apparatus 900 may be used to implement one or more aspects described herein. For example, the apparatus 900 may be configured to perform operations performed by a distributed database, a primary node, a replica node and the like as may appreciated by a person skilled in the art.

As shown, the apparatus 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. According to certain embodiments, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 930 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
at a primary node of a distributed database:
receiving a first transaction to update a first table of the distributed database, the first table being associated with a first policy according to which the first transaction is to commit;
generating a first queue associated with the first table, the first queue indicating the first transaction;
receiving a second transaction to update a second table of the distributed database, the second table being associated with a second policy according to which the second transaction is to commit, the second policy being different than the first policy;
generating a second queue associated with the second table, the second queue indicating the second transaction;
receiving, from a set of replica nodes of the distributed database, data indicating a status of the set of replica nodes with respect to one or more of: the first transaction and the second transaction;
determining that at least one of the first policy and the second policy is satisfied based on the received data, to obtain a determination; and
committing at least one of the first transaction and the second transaction based on the determination.

2. The method of claim 1, wherein each of the first policy and the second policy is based on a flushed log sequence number (LSN) at one or more replica nodes of the set of replica nodes.

3. The method of claim 2, wherein receiving the data comprises receiving from each of the set of replica nodes, the data indicating a flushed LSN at said each replica node.

4. The method of claim 2, wherein:
generating the first queue comprises indicating the first transaction via a first LSN; and
generating the second queue comprises indicating the second transaction via a second LSN.

5. The method of claim 4, wherein
indicating the first transaction comprising indicating the first transactions via the first LSN associated with a last update of the first transaction; and
indicating the second transaction comprises indicating the second transaction via the second LSN associated with a last update of the second transaction.

6. The method of claim 1, wherein each of the first policy and the second policy is based on one or more of:
a flushed log sequence number (LSN) at a first subset of the set of replica nodes;
an applied LSN at a second subset of the set of replica nodes; and
an applied transaction timestamp at a third subset of the set of replica nodes.

7. The method of claim 6, wherein receiving the data comprises receiving from each of the set of replica nodes, the data indicating one or more of: a flushed LSN, an applied LSN, and an applied transaction timestamp.

8. The method of claim 6 wherein:
generating the first queue comprises indicating the first transaction via one of: a first LSN and a first transaction timestamp; and
generating the second queue comprises indicating the second transaction via one of: a second LSN and a second transaction timestamp.

9. The method of claim 1 further comprising:
creating the first table; and
assigning the first policy to the first table.

10. The method of claim 9, wherein
assigning the first policy to the first table comprises updating metadata of the first table to indicate the first policy.

11. The method of claim 9 further comprising:
creating the second table; and
assigning the second policy to the first table.

12. The method of claim 9 further comprising modifying the first table's policy to obtain a third policy.

13. The method of claim 12 further comprising:
receiving a third transaction to update the first table, the third transaction to commit according to the third policy; and
generating a third queue associated with the first table, the third queue indicating the third transaction.

14. The method of claim 12 wherein modifying the first table's policy comprises updating the metadata of the first table to indicate the third policy.

15. An apparatus comprising:
at least one processor and at least one machine-readable medium storing executable instructions which when executed by the at least one processor configure a primary node of a distributed database for:
receiving a first transaction to update a first table of the distributed database, the first table being associated with a first policy according to which the first transaction is to commit;
generating a first queue associated with the first table, the first queue indicating the first transaction;
receiving a second transaction to update a second table of the distributed database, the second table being associated with a second policy according to which the second transaction is to commit, the second policy being different than the first policy;
generating a second queue associated with the second table, the second queue indicating the second transaction;
receiving, from a set of replica nodes of the distributed database, data indicating a status of the set of replica nodes with respect to one or more of: the first transaction and the second transaction;
determining that at least one of the first policy and the second policy is satisfied based on the received data, to obtain a determination; and
committing at least one of the first transaction and the second transaction based on the determination.

16. The apparatus of claim 15, wherein each of the first policy and the second policy is based on one or more of:
a flushed log sequence number (LSN) at one or more replica nodes of the set of replica nodes;
an applied LSN at the one or more replica nodes of the set of replica nodes; and
an applied transaction timestamp at the one or more replica nodes of the set of replica nodes.

17. The apparatus of claim 16, wherein the configuration for receiving the data further configures the primary node for receiving from each of the set of replica nodes the data indicating one or more of: a flushed LSN, an applied LSN, and an applied transaction timestamp.

18. The apparatus of claim 16, wherein:
the configuration for generating a first queue further configure the primary node for indicating the first transaction via one of: a first LSN and a first transaction timestamp; and
the configuration for generating a second queue further configure the primary node for indicating the second transaction via one of: a second LSN and a second transaction timestamp.

19. The apparatus of claim 15 wherein the executable instructions which when executed by the at least one processor further configures the primary node for:
creating the first table; and
assigning the first policy to the first table.

20. The apparatus of claim 19, wherein the executable instructions which when executed by the at least one processor further configures the primary node for:
modifying the first table's policy to obtain a third policy.
